(19) United States
(12) Patent Application Publication
(10) Pub. No.: US 2022/0204023 A1
(43) Pub. Date: Jun. 30, 2022

(54) VEHICLE CONTROL SYSTEM AND ROAD SHOULDER ENTRY DETERMINING METHOD

(71) Applicant: HONDA MOTOR CO., LTD., Tokyo (JP)

(72) Inventor: Koichiro WADA, Saitama (JP)

(21) Appl. No.: 17/559,106

(22) Filed: Dec. 22, 2021

(30) Foreign Application Priority Data
Dec. 28, 2020 (JP) 2020-219134

(51) Int. Cl. B60W 60/00; G01C 21/00; B60W 30/09

(52) U.S. Cl. CPC B60W 60/001; B60W 30/09; G01C 21/3819

(57) ABSTRACT

A vehicle control system includes a map generating unit configured to generate a map of a surrounding area of a vehicle, and a road shoulder determining unit configured to determine whether the vehicle has entered a road shoulder on the map. The road shoulder determining unit is configured to identify an own lane on which the vehicle is traveling on the map, determine whether an adjacent lane adjacent to the own lane is present on the map, determine whether the vehicle has crossed an own delimiting line that delimits the own lane on the map, and determine that the vehicle has entered the road shoulder on the map upon determining that the adjacent lane is not present on one lateral side of the own lane and that the vehicle has crossed the own delimiting line on the one lateral side.

### TECHNICAL FIELD

The present invention relates to a vehicle control system and a road shoulder entry determining method.

### BACKGROUND ART

Conventionally, various methods have been proposed for causing a vehicle to enter a road shoulder and stop there when emergency stop control or the like is executed. For example, a vehicle control method disclosed in JP2020-15443A executes a process for stopping a vehicle at a road shoulder by autonomous driving upon determining that the road shoulder is present on one lateral side of the vehicle.

In order to reliably stop the vehicle on the road shoulder, there is a request to accurately determine that the vehicle has entered the road shoulder. However, the vehicle control method disclosed in JP2020-15443A does not take any measures to accurately determine that the vehicle has entered the road shoulder, and thus may not fully respond to the above request.

### SUMMARY OF THE INVENTION

In view of the above background, an object of the present invention is to provide a vehicle control system and a road shoulder entry determining method that can accurately determine that the vehicle has entered the road shoulder.

To achieve such an object, one aspect of the present invention provides a vehicle control system (1) comprising: a map generating unit (53) configured to generate a map of a surrounding area of a vehicle (V); and a road shoulder determining unit (54) configured to determine whether the vehicle has entered a road shoulder (D) on the map, wherein the road shoulder determining unit is configured to identify an own lane (A) on which the vehicle is traveling on the map, determine whether an adjacent lane (B) adjacent to the own lane is present on the map, determine whether the vehicle has crossed an own delimiting line (A2) that delimits the own lane on the map, and determine that the vehicle has entered the road shoulder on the map upon determining that the adjacent lane is not present on one lateral side of the own lane and that the vehicle has crossed the own delimiting line on the one lateral side.

According to this aspect, it is possible to accurately determine that the vehicle has entered the road shoulder on the map. In particular, by determining that the vehicle has entered the road shoulder on the map only when determining that the adjacent lane is not present on the one lateral side of the own lane, it is possible to reliably avoid determining that the vehicle has entered the road shoulder even though the vehicle has entered the adjacent lane.

In the above aspect, preferably, the road shoulder determining unit keeps on determining that the vehicle is present on the road shoulder after determining that the vehicle has entered the road shoulder on the map and until determining that the vehicle has crossed the own delimiting line again to return to the own lane on the map.

According to this aspect, after the vehicle has entered the road shoulder, it is possible to accurately determine whether the vehicle is present on the road shoulder. Accordingly, when emergency stop control is executed, the vehicle can be surely stopped on the road shoulder.

In the above aspect, preferably, the road shoulder determining unit determines that the vehicle is present on the road shoulder in a case where a prescribed period has passed after determining that the vehicle has entered the road shoulder on the map without determining that the vehicle has crossed the own delimiting line again to return to the own lane on the map.

According to this aspect, in a case where the vehicle returns to the own lane immediately after entering the road shoulder, the road shoulder determining unit can avoid determining that the vehicle is present on the road shoulder.

In the above aspect, preferably, in a case where the adjacent lane can be identified on one side of the vehicle on the map and a distance between a center line (A1) of the own lane and a center line (B1) of the adjacent lane on the map is less than a prescribed reference value (R), the road shoulder determining unit determines that the adjacent lane is present.

According to this aspect, it is possible to accurately determine whether the adjacent lane is present, and thus more accurately determine that the vehicle has entered the road shoulder on the map.

In the above aspect, preferably, in a case where a center (V1) of the vehicle has crossed the own delimiting line and has shifted from the own delimiting line by a prescribed reference length (L) or more on the map, the road shoulder determining unit determines that the vehicle has crossed the own delimiting line regardless of whether a whole of the vehicle has crossed the own delimiting line.

According to this aspect, it is possible to accurately determine whether the vehicle has crossed the own delimiting line, and thus more accurately determine that the vehicle has entered the road shoulder on the map.

In the above aspect, preferably, the vehicle control system further comprises a travel control unit (42) configured to control travel of the vehicle, wherein the travel control unit is configured to execute emergency stop control to cause the vehicle to autonomously travel to a prescribed stop position and stop at the stop position upon determining that it is difficult to continue the travel of the vehicle, when the emergency stop control is not executed, the travel control unit prohibits the vehicle from traveling on the road shoulder, and when the emergency stop control is executed, the travel control unit permits the vehicle to travel on the road shoulder until the vehicle stops at the stop position on the road shoulder.

According to this aspect, by temporarily permitting the vehicle to travel on the road shoulder when the emergency stop control is executed, the vehicle can be stopped at an appropriate stop position on the road shoulder.

In the above aspect, preferably, the road shoulder determining unit is configured to determine whether information on the map is available, and determine that the vehicle has entered the road shoulder on the map upon determining that the information on the map is available, that the adjacent lane is not present on the one lateral side of the own lane, and that the vehicle has crossed the own delimiting line on the one lateral side.

According to this aspect, by determining that the vehicle has entered the road shoulder on the map only when the information on the map is available, it is possible to more accurately determine that the vehicle has entered the road shoulder on the map.

In the above aspect, preferably, in a case where a position of the vehicle can be estimated on the map, the road shoulder determining unit determines that the information on the map is available, and in a case where the position of the vehicle cannot be estimated on the map, the road shoulder determining unit determines that the information on the map is not available.

According to this aspect, it is possible to accurately determine whether the information on the map is available, and thus more accurately determine that the vehicle has entered the road shoulder on the map.

To achieve the above object, another aspect of the present invention provides a road shoulder entry determining method for determining whether a vehicle (V) has entered a road shoulder (D) on a map, the road shoulder entry determining method comprising: identifying an own lane (A) on which the vehicle is traveling on the map, determining whether an adjacent lane (B) adjacent to the own lane is present on the map, determining whether the vehicle has crossed an own delimiting line (A2) that delimits the own lane on the map, and determining that the vehicle has entered the road shoulder on the map upon determining that the adjacent lane is not present on at least one lateral side of the own lane and that the vehicle has crossed the own delimiting line on the one lateral side.

According to this aspect, it is possible to accurately determine that the vehicle has entered the road shoulder on the map. In particular, by determining that the vehicle has entered the road shoulder on the map only when determining that the adjacent lane is not present on the one lateral side of the own lane, it is possible to reliably avoid determining that the vehicle has entered the road shoulder even though the vehicle has entered the adjacent lane.

Thus, according to the above aspects, it is possible to provide a vehicle control system and a road shoulder entry determining method that can accurately determine that the vehicle has entered the road shoulder.

### BRIEF DESCRIPTION OF THE DRAWING(S)

FIG. 1 is a block diagram of a vehicle control system according to an embodiment of the present invention;

FIG. 2 is a flowchart showing entry determining control according to the embodiment of the present invention;

FIG. 3 is a plan view showing a presence determining process according to the embodiment of the present invention; and

FIG. 4 is a plan view showing a crossing determining process according to the embodiment of the present invention.

### DETAILED DESCRIPTION OF THE INVENTION

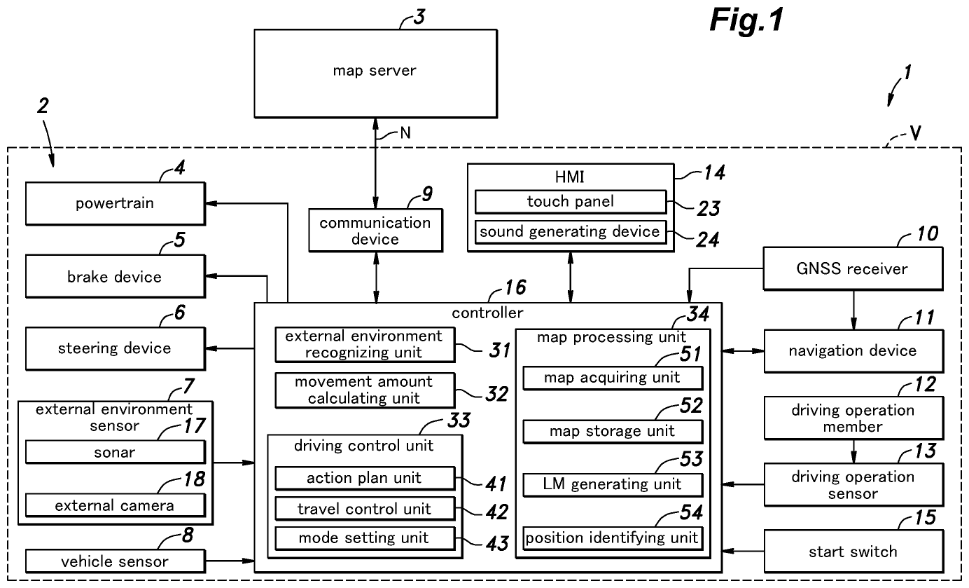

In the following, a vehicle control system 1 according to an embodiment of the present invention will be described with reference to the drawings. As shown in FIG. 1, the vehicle control system 1 includes a vehicle system 2 mounted on a vehicle V, and a high-precision map server 3 (hereinafter, abbreviated as “the map server 3”) connected to the vehicle system 2 via a network N. Hereinafter, the word “the vehicle V” indicates a vehicle (namely, the own vehicle) provided with the vehicle system 2.

### <The Vehicle System 2>

First, the vehicle system 2 will be described. The vehicle system 2 includes a powertrain 4, a brake device 5, a steering device 6, an external environment sensor 7, a vehicle sensor 8, a communication device 9, a GNSS receiver 10, a navigation device 11, a driving operation member 12, a driving operation sensor 13, an HMI 14, a start switch 15, and a controller 16. Each component of the vehicle system 2 is connected to each other via a communication means such as Controller Area Network (CAN) such that signals can be transmitted therebetween.

The powertrain 4 is a device configured to apply a driving force to the vehicle V. For example, the powertrain 4 includes at least one of an internal combustion engine (such as a gasoline engine and a diesel engine) and an electric motor. The brake device 5 is a device configured to apply a brake force to the vehicle V. For example, the brake device 5 includes a brake caliper configured to press a pad against a brake rotor and an electric cylinder configured to supply an oil pressure to the brake caliper. The brake device 5 may further include a parking brake device configured to restrict rotation of wheels via wire cables. The steering device 6 is a device configured to change the steering angles of the wheels. For example, the steering device 6 includes a rack-and-pinion mechanism configured to steer the wheels and an electric motor configured to drive the rack-and-pinion mechanism. The powertrain 4, the brake device 5, and the steering device 6 are controlled by the controller 16.

The external environment sensor 7 is a sensor configured to detect an object outside the vehicle V or the like by capturing electromagnetic waves, sound waves, or the like from the surroundings of the vehicle V. The external environment sensor 7 includes a plurality of sonars 17 and a plurality of external cameras 18 (an example of an imaging device). The external environment sensor 7 may further include a millimeter wave radar and/or a laser lidar. The external environment sensor 7 is configured to output a detection result to the controller 16.

Each sonar 17 consists of a so-called ultrasonic sensor. The sonar 17 emits ultrasonic waves to the surroundings of the vehicle V and captures the reflected waves therefrom, thereby detecting a position (distance and direction) of the object. The plurality of sonars 17 is provided at a rear part and a front part of the vehicle V, respectively.

Each external camera 18 is a device configured to capture an image of the surroundings of the vehicle V. For example, the external camera 18 is a digital camera that uses a solid imaging element such as a CCD and a CMOS. The external camera 18 may consist of a stereo camera or a monocular camera. The plurality of external cameras 18 include a front camera configured to capture an image in front of the vehicle V, a rear camera configured to capture an image behind the vehicle V, and a pair of side cameras configured to capture images on both lateral sides of the vehicle V. When the vehicle V is traveling, each external camera 18 captures an image of a travel route on which the vehicle V is traveling at prescribed intervals (for example, at prescribed spatial intervals or prescribed temporal intervals).

The vehicle sensor 8 is a sensor configured to detect the state of the vehicle V. The vehicle sensor 8 includes a vehicle speed sensor configured to detect the speed of the vehicle V, an acceleration sensor configured to detect the acceleration of the vehicle V, a yaw rate sensor configured to detect the angular velocity around a vertical axis of the vehicle V, a direction sensor configured to detect the direction of the vehicle V, and the like. For example, the yaw rate sensor consists of a gyro sensor. The vehicle sensor 8 may further include an inclination sensor configured to detect the inclination of a vehicle body and a wheel speed sensor configured to detect the rotational speed of each wheel.

The communication device 9 is configured to mediate communication between the controller 16 and a device (for example, the map server 3) outside the vehicle V. The communication device 9 includes a router configured to connect the controller 16 to the Internet. The communication device 9 may have a wireless communication function of mediating wireless communication between the controller 16 of the vehicle V and the controller of the surrounding vehicle and between the controller 16 of the vehicle V and a roadside device on a road.

The GNSS receiver 10 is configured to receive a signal (hereinafter referred to as “the GNSS signal”) relating to the position (latitude and longitude) of the vehicle V from each of satellites that constitute a Global Navigation Satellite System (GNSS). The GNSS receiver 10 is configured to output the received GNSS signal to the navigation device 11 and the controller 16.

The navigation device 11 consists of a computer provided with known hardware. The navigation device 11 is configured to identify the position (latitude and longitude) of the vehicle V based on the previous traveling history of the vehicle V and the GNSS signal output from the GNSS receiver 10. The navigation device 11 is configured to store data (hereinafter referred to as “the navigation map data”) on roads of a region or a country on which the vehicle V is traveling. The navigation device 11 is configured to store the navigation map data in a RAM, an HDD, an SSD, or the like.

The navigation device 11 is configured to set, based on the GNSS signal and the navigation map data, a route from a current position of the vehicle V to a destination input by an occupant, and output the route to the controller 16. When the vehicle V starts traveling, the navigation device 11 provides the occupant with route guidance to the destination.

The driving operation member 12 is provided in a vehicle cabin and configured to accept an input operation the occupant performs to control the vehicle V. The driving operation member 12 includes a steering wheel, an accelerator pedal, and a brake pedal. The driving operation member 12 may further include a shift lever, a parking brake lever, a blinker lever, and the like.

The driving operation sensor 13 is a sensor configured to detect an operation amount of the driving operation member 12. The driving operation sensor 13 includes a steering angle sensor configured to detect an operation amount of the steering wheel, an accelerator sensor configured to detect an operation amount of the accelerator pedal, and a brake sensor configured to detect an operation amount of the brake pedal. The driving operation sensor 13 is configured to output the detected operation amount to the controller 16. The driving operation sensor 13 may further include a grip sensor configured to detect that the occupant grips the steering wheel. For example, the grip sensor consists of at least one capacitive sensor provided on an outer circumferential portion of the steering wheel.

The HMI 14 is configured to notify the occupant of various kinds of information by display and/or voice, and accept an input operation by the occupant. For example, the HMI 14 includes a touch panel 23 and a sound generating device 24. The touch panel 23 includes a liquid crystal display, an organic EL display, or the like, and is configured to accept the input operation by the occupant. The sound generating device 24 consists of a buzzer and/or a speaker. The HMI 14 is configured to display a driving mode switch button on the touch panel 23. The driving mode switch button is a button configured to accept a switching operation of a driving mode (for example, an autonomous driving mode and a manual driving mode) of the vehicle V by the occupant.

The HMI 14 also functions as an interface to mediate the input to/the output from the navigation device 11. Namely, when the HMI 14 accepts the input operation of the destination by the occupant, the navigation device 11 starts a route setting to the destination. Further, when the navigation device 11 provides the route guidance to the destination, the HMI 14 displays the current position of the vehicle V and the route to the destination.

The start switch 15 is a switch for starting the vehicle system 2. Namely, the occupant presses the start switch 15 while sitting on the driver's seat and pressing the brake pedal, and thus the vehicle system 2 is started.

The controller 16 consists of at least one electronic control unit (ECU) including a CPU, a ROM, a RAM, and the like. The CPU executes operation processing according to a program, and thus the controller 16 executes various types of vehicle control. The controller 16 may consist of one piece of hardware, or may consist of a unit including plural pieces of hardware. The functions of the controller 16 may be at least partially executed by hardware such as an LSI, an ASIC, and an FPGA, or may be executed by a combination of software and hardware.

The controller 16 includes an external environment recognizing unit 31 (an example of a delimiting line estimating unit), a movement amount calculating unit 32, a driving control unit 33, and a map processing unit 34. These components may be composed of separate electronic control units or integrated electronic control units.

The external environment recognizing unit 31 is configured to recognize an object that is present in the surroundings of the vehicle V based on the detection result of the external environment sensor 7, and thus acquire information on the position and size of the object. The object recognized by the external environment recognizing unit 31 includes delimiting lines, lanes, road ends, road shoulders, and obstacles, which are present on the travel route of the vehicle V. Each delimiting line is a line shown along a vehicle travel direction. Each lane is an area delimited by one or more delimiting lines. Each road end is an end of the travel route of the vehicle V. Each road shoulder is an area between the delimiting line arranged at an end in the vehicle width direction (lateral direction) and the road end. Each obstacle may be a barrier (guardrail), a utility pole, a surrounding vehicle, a pedestrian, or the like.

The external environment recognizing unit 31 is configured to recognize, based on the image (hereinafter referred to as “the camera image”) captured by each external camera 18, the position of the delimiting line (hereinafter referred to as “the camera delimiting line”) in the camera image. For example, the external environment recognizing unit 31 is configured to extract points (hereinafter referred to as “the candidate points”) whose density value changes by a threshold or more in the camera image, and recognize a straight line passing through the candidate points as the camera delimiting line. The external environment recognizing unit 31 is configured to identify the type of the camera delimiting line based on the camera image. The type of the camera delimiting line includes a single solid line, a single broken line, a deceleration promotion line, and a double solid line. The deceleration promotion line consists of, for example, a broken line with shorter intervals and a greater width than the single broken line.

The movement amount calculating unit 32 is configured to calculate, based on the signal from the vehicle sensor 8, a movement amount of the vehicle V (a movement distance and a movement direction of the vehicle V) by using dead reckoning such as odometry and inertial navigation. For example, the movement amount calculating unit 32 is configured to calculate the movement amount of the vehicle V based on the rotational speed of each wheel detected by the wheel speed sensor, the acceleration of the vehicle V detected by the acceleration sensor, and the angular velocity of the vehicle V detected by the gyro sensor. Hereinafter, the movement amount of the vehicle V the movement amount calculating unit 32 calculates by using dead reckoning will be referred to as “the DR movement amount of the vehicle V”.

The driving control unit 33 includes an action plan unit 41, a travel control unit 42, and a mode setting unit 43.

The action plan unit 41 is configured to create an action plan for causing the vehicle V to travel along the route set by the navigation device 11. The action plan unit 41 is configured to output a travel control signal corresponding to the created action plan to the travel control unit 42.

The travel control unit 42 is configured to control the powertrain 4, the brake device 5, and the steering device 6 based on the travel control signal from the action plan unit 41. Namely, the travel control unit 42 is configured to cause the vehicle V to travel according to the action plan created by the action plan unit 41.

The mode setting unit 43 is configured to switch the driving mode of the vehicle V between the manual driving mode and the autonomous driving mode. In the manual driving mode, the travel control unit 42 controls the powertrain 4, the brake device 5, and the steering device 6 according to the input operation on the driving operation member 12 by the occupant, thereby causing the vehicle V to travel. On the other hand, in the autonomous driving mode, the travel control unit 42 controls the powertrain 4, the brake device 5, and the steering device 6 regardless of the input operation on the driving operation member 12 by the occupant, thereby causing the vehicle V to travel autonomously.

The map processing unit 34 includes a map acquiring unit 51, a map storage unit 52, a local map generating unit 53 (an example of a map generating unit: hereinafter referred to as “the LM generating unit 53”), and a position identifying unit 54 (an example of a road shoulder determining unit).

The map acquiring unit 51 is configured to access the map server 3 and acquire dynamic map data (which will be described in detail later) from the map server 3. For example, the map acquiring unit 51 is configured to acquire, from the map server 3, the dynamic map data of an area corresponding to the route set by the navigation device 11.

The map storage unit 52 consists of a storage unit such as an HDD and an SSD. The map storage unit 52 is configured to store various kinds of information for causing the vehicle V to travel autonomously in the autonomous driving mode. The map storage unit 52 is configured to store the dynamic map data acquired by the map acquiring unit 51 from the map server 3.

The LM generating unit 53 is configured to generate a detailed map (hereinafter referred to as “the local map”) of the surrounding area of the vehicle V based on the dynamic map data stored in the map storage unit 52. The LM generating unit 53 is configured to generate the local map by extracting the data relating to the surrounding area of the vehicle V from the dynamic map data. Accordingly, the local map may include any information included in the dynamic map data. For example, the local map includes information on the lanes (for example, the number of lanes and the lane number of each lane) on the travel route and information on each delimiting line (for example, the type of the delimiting line) on the travel route. Further, the local map may include information on the object (for example, the obstacle) recognized by the external environment recognizing unit 31 based on the camera image and information on the past DR movement amount of the vehicle V (namely, the movement trajectory of the vehicle V). When the vehicle V is traveling autonomously in the autonomous driving mode, the LM generating unit 53 may update the local map at any time according to the travel position of the vehicle V.

The position identifying unit 54 is configured to execute various kinds of localization processes on the local map. For example, the position identifying unit 54 is configured to estimate the position of the vehicle V on the local map based on the GNSS signal output from the GNSS receiver 10, the DR movement amount of the vehicle V, the camera image, and the like. Further, the position identifying unit 54 is configured to identify the position of an own lane (a lane in which the vehicle V is traveling) on the local map based on the GNSS signal output from the GNSS receiver 10, the camera image, and the like. When the vehicle V is traveling autonomously in the autonomous driving mode, the position identifying unit 54 may update the position of the vehicle V and the position of the own lane on the local map at any time according to the travel position of the vehicle V.

### <The Map Server 3>

Next, the map server 3 will be described. As shown in FIG. 1, the map server 3 is connected to the controller 16 via the network N (in the present embodiment, the Internet) and the communication device 9. The map server 3 is a computer including a CPU, a ROM, a RAM, and a storage unit such as an HDD and an SSD. The dynamic map data is stored in the storage unit of the map server 3.

The dynamic map data includes static information, semi-static information, semi-dynamic information, and dynamic information. The static information includes 3D map data that is more precise than the navigation map data. The semi-static information includes traffic regulation information, road construction information, and wide area weather information. The semi-dynamic information includes accident information, traffic congestion information, and small area weather information. The dynamic information includes signal information, surrounding vehicle information, and pedestrian information.

The static information of the dynamic map data includes information on lanes (for example, the number of lanes and the lane number of each lane) on the travel route and information on each delimiting line on the travel route (for example, the type of the delimiting line). For example, the delimiting line in the static information is represented by nodes arranged at prescribed intervals and links connecting the nodes.

### <The Entry Determining Control>

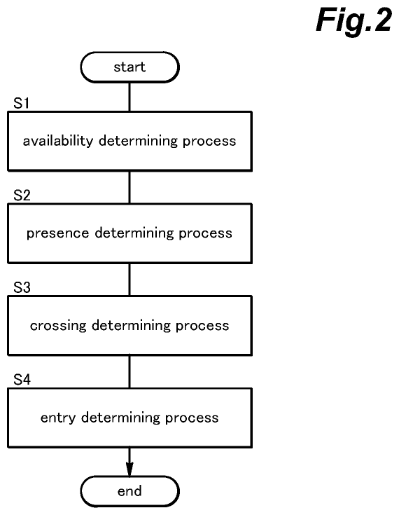

Next, an outline of entry determining control (an example of a road shoulder entry determining method) for determining whether the vehicle V has entered the road shoulder D on the local map will be described with reference to FIG. 2.

When the entry determining control is started, the position identifying unit 54 of the controller 16 executes an availability determining process (step S1). In the availability determining process, the position identifying unit 54 determines whether information on the local map is available.

Next, the position identifying unit 54 executes a presence determining process (step S2). In the presence determining process, the position identifying unit 54 determines whether an adjacent lane B adjacent to an own lane A (a lane on which the vehicle V is traveling) is present on the local map.

Next, the position identifying unit 54 executes a crossing determining process (step S3). In the crossing determining process, the position identifying unit 54 determines whether the vehicle V has crossed the delimiting lines that delimit (divide) the own lane A and the adjacent lane B on the local map.

Next, the position identifying unit 54 executes an entry determining process (step S4). In the entry determining process, the position identifying unit 54 determines whether the vehicle V has entered the road shoulder D on the local map based on the determination results of the availability determining process, the presence determining process, and the crossing determining process.

### <The Availability Determining Process>

Next, the availability determining process (step S1) of the entry determining control will be described.

In the availability determining process, the position identifying unit 54 determines whether the information on the local map is available, and sets 1 or 0 as an availability determination flag according to the determination result thereof. For example, in a case where the position identifying unit 54 can estimate the position of the vehicle V on the local map based on the GNSS signal, the DR movement amount of the vehicle V, the comparing result of the camera image and the local map, and the like, the position identifying unit 54 determines that the information on the local map is available, and sets 1 as the availability determination flag. On the other hand, in a case where the position identifying unit 54 cannot estimate the position of the vehicle V on the local map based on the GNSS signal, the DR movement amount of the vehicle V, the comparing result of the camera image and the local map, and the like, the position identifying unit 54 determines that the information on the local map is not available, and sets 0 as the availability determination flag.

Further, in a case where the position identifying unit 54 determines that the information on the local map is available in the availability determining process (namely, in a case where the position identifying unit 54 can estimate the position of the vehicle V on the local map), the position identifying unit 54 may identify the own lane A on the local map based on the position of the vehicle V on the local map. For example, in a case where only one lane is present in a specific area including the position of the vehicle V on the local map, the position identifying unit 54 may identify the above one lane as the own lane A on the local map. On the other hand, in a case where a plurality of lanes are present in the above specific area on the local map, the position identifying unit 54 may compare the type of the delimiting lines of the own lane recognized from the camera image with the type of the delimiting lines of the above lanes, thereby identifying one of the lanes as the own lane A on the local map.

### <The Presence Determining Process>

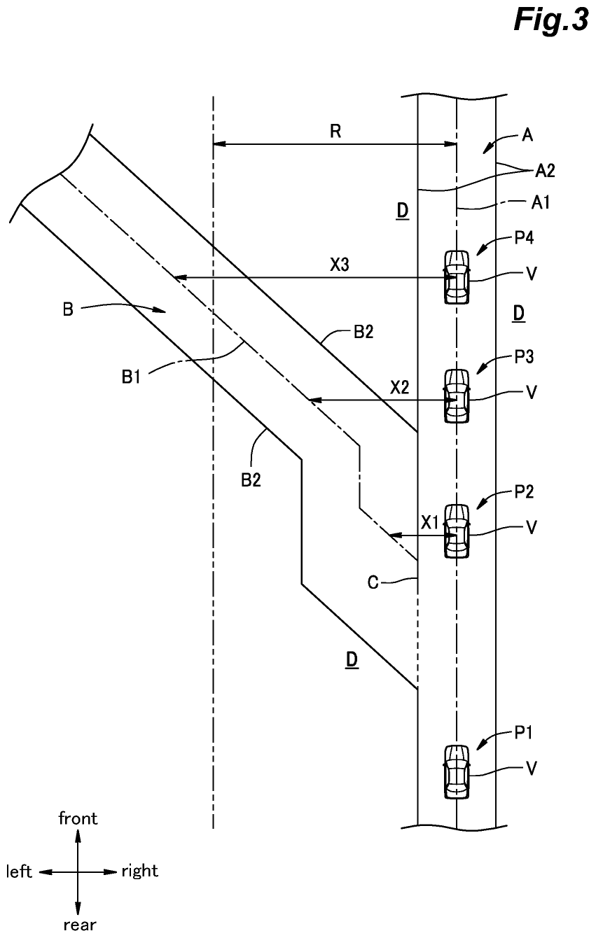

Next, the presence determining process (step S2) of the entry determining control will be described with reference to FIG. 3. FIG. 3 shows the local map of some area. The position identifying unit 54 executes the presence determining process for both lateral areas (left and right areas) of the own lane A on the local map respectively. In the following, only the presence determining process executed for the left area of the own lane A on the local map will be described, and the description of the presence determining process executed for the right area of the own lane A on the local map will be omitted.

In the presence determining process, the position identifying unit 54 determines whether the following conditions 1 and 2 are satisfied, and sets 1 or 0 as a presence determination flag according to the determination result thereof.

### Condition 1

The position identifying unit 54 can identify the adjacent lane B on the left side of the vehicle V (namely, right next to the vehicle V) on the local map.

### Condition 2

The distance in the lateral direction between a center line A1 of the own lane A and a center line B1 of the adjacent lane B on the local map is less than a prescribed reference value R.

In a case where both the conditions 1 and 2 are satisfied, the position identifying unit 54 determines that the adjacent lane B is present on the left side of the own lane A, and sets 1 as the presence determination flag. On the other hand, in a case where at least one of the conditions 1 and 2 is not satisfied, the position identifying unit 54 determines that the adjacent lane B is not present on the left side of the own lane A, and sets 0 as the presence determination flag.

For example, in a first position P1 in FIG. 3, the adjacent lane B cannot be identified on the left side of the vehicle V on the local map. Namely, in the first position P1 in FIG. 3, the condition 1 is not satisfied. Accordingly, the position identifying unit 54 determines that the adjacent lane B is not present on the left side of the own lane A, and sets 0 as the presence determination flag.

For example, in a second position P2 and a third position P3 in FIG. 3, the adjacent lane B can be identified on the left side of the vehicle V on the local map, and distances X1 and X2 in the lateral direction between the center line A1 of the own lane A and the center line B1 of the adjacent lane B on the local map are less than the reference value R. Namely, in the second position P2 and the third position P3 in FIG. 3, both the conditions 1 and 2 are satisfied. Accordingly, the position identifying unit 54 determines that the adjacent lane B is present on the left side of the own lane A, and sets 1 as the presence determination flag.

For example, in a fourth position P4 in FIG. 3, the adjacent lane B can be identified on the left side of the vehicle V on the local map, but a distance X3 in the lateral direction between the center line A1 of the own lane A and the center line B1 of the adjacent lane B is more than the reference value R. Namely, in the fourth position P4 of FIG. 3, the condition 2 is not satisfied. Accordingly, the position identifying unit 54 determines that the adjacent lane B is not present on the left side of the own lane A, and sets 0 as the presence determination flag.

### <The Crossing Determining Process>

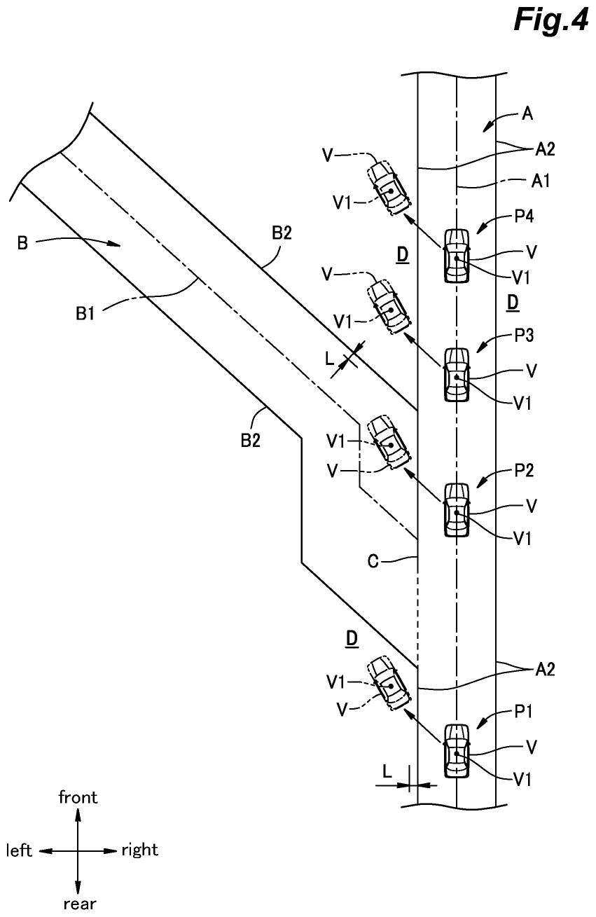

Next, the crossing determining process (step S3) of the entry determining control will be described with reference to FIG. 4. FIG. 4 shows the local map of the same area as shown in FIG. 3. The position identifying unit 54 executes the crossing determining process for both lateral areas (left and right areas) of the own lane A on the local map respectively. In the following, only the crossing determining process executed for the left area of the own lane A on the local map will be described, and the description of the crossing determining process executed for the right area of the own lane A on the local map will be omitted.

The position identifying unit 54 determines whether the vehicle V has crossed a delimiting line A2 (hereinafter referred to as “the left own delimiting line A2”) that delimits (divides) the own lane A and an area on the left side thereof on the local map. For example, the position identifying unit 54 determines that the vehicle V has crossed the left own delimiting line A2 in a case where the center V1 of the vehicle V has crossed the left own delimiting line A2 and has shifted from the left own delimiting line A2 by a prescribed reference length L or more on the local map. The reference length L is shorter than half the width of the vehicle V. Accordingly, the position identifying unit 54 determines that the vehicle V has crossed the left own delimiting line A2 even when the whole of the vehicle V has not crossed the left own delimiting line A2.

Similarly, the position identifying unit 54 determines whether the vehicle V has crossed a delimiting line B2 (hereinafter referred to as “the right adjacent delimiting line B2”) that delimits (divides) the adjacent lane B and an area on the right side thereof on the local map. For example, the position identifying unit 54 determines that the vehicle V has crossed the right adjacent delimiting line B2 in a case where the center V1 of the vehicle V has crossed the right adjacent delimiting line B2 and has shifted from the right adjacent delimiting line B2 by the reference length L or more on the local map.

Upon determining that the vehicle V has crossed the left own delimiting line A2 but has not crossed the right adjacent delimiting line B2 (namely, upon determining that the vehicle V has crossed only the left own delimiting line A2), the position identifying unit 54 sets 1 as a crossing determination flag. On the other hand, upon determining that the vehicle V has crossed neither the left own delimiting line A2 nor the right adjacent delimiting line B2 or that the vehicle V has crossed both the left own delimiting line A2 and the right adjacent delimiting line B2, the position identifying unit 54 sets 0 as the crossing determination flag.

The first position P1 to the fourth position P4 in FIG. 4 are the same as the first position P1 to the fourth position P4 in FIG. 3 respectively. In the first position P1 of FIG. 4, the left own delimiting line A2 is present, but the right adjacent delimiting line B2 is not present. Accordingly, when the vehicle V has crossed the left own delimiting line A2, the position identifying unit 54 determines that the vehicle V has crossed the left own delimiting line A2 but has not crossed the right adjacent delimiting line B2, and sets 1 as the crossing determination flag.

In the second position P2 in FIG. 4, one delimiting line C (hereinafter referred to as “the common delimiting line C”) that functions as both the left own delimiting line A2 and the right adjacent delimiting line B2 is present between the own lane A and the adjacent lane B. Accordingly, when the vehicle V has crossed the common delimiting line C, the position identifying unit 54 determines that the vehicle V has crossed both the left own delimiting line A2 and the right adjacent delimiting line B2, and sets 0 as the crossing determination flag.

In the third position P3 and the fourth position P4 in FIG. 4, the left own delimiting line A2 and the right adjacent delimiting line B2 are separately present between the own lane A and the adjacent lane B. Accordingly, when the vehicle V has crossed the left own delimiting line A2, the position identifying unit 54 determines that the vehicle V has crossed the left own delimiting line A2 but has not crossed the right adjacent delimiting line B2, and sets 1 as the crossing determination flag.

In another embodiment, in the crossing determining process, the position identifying unit 54 may determine only whether the vehicle V has crossed the own delimiting line A2 without determining whether the vehicle V has crossed the adjacent delimiting line B2.

### <The Entry Determining Process>

Next, the entry determining process (step S4) of the entry determining control will be described. The position identifying unit 54 executes the entry determining process for both lateral areas (left and right areas) of the own lane A on the local map respectively. In the following, only the entry determining process executed for the left area of the own lane A on the local map will be described, and the description of the entry determining process executed for the right area of the own lane A on the local map will be omitted. Hereinafter, the presence determination flag, the crossing determination flag, and the road shoulder determination flag relating to the left area of the own lane A on the local map will be referred to as the presence determination flag (L), the crossing determination flag (L), and the road shoulder determination flag (L) respectively. Similarly, the presence determination flag, the crossing determination flag, and the road shoulder determination flag relating to the right area of the own lane A on the local map will be referred to as the presence determination flag (R), the crossing determination flag (R), and the road shoulder determination flag (R) respectively.

In the entry determining process, in a case where all of the following conditions A to C are satisfied, the position identifying unit 54 determines that the vehicle V has entered the left road shoulder D on the local map, and sets 1 as the road shoulder determination flag (L). On the other hand, in a case where at least one of the following conditions A to C is not satisfied, the position identifying unit 54 determines that the vehicle V has not entered the left road shoulder D on the local map, and sets 0 as the road shoulder determination flag (L).

### Condition A

1 is set as the availability determination flag, that is, the information on the local map is available.

### Condition B

0 is set as the presence determination flag (L), that is, the adjacent lane B is not present on the left side of the own lane A.

### Condition C

1 is set as the crossing determination flag (L), that is, the vehicle V has crossed the left own delimiting line A2 but has not crossed the right adjacent delimiting line B2.

In a case where 1 is set as the crossing determination flag (L), the position identifying unit 54 uses 1 as the crossing determination flag (L) for the determination of the condition C. On the other hand, in a case where 0 is set as the crossing determination flag (L), the position identifying unit 54 determines the crossing determination flag (L) to be used for the determination of the condition C according to the following rules 1 and 2.

### Rule 1

In a case where 1 is set as the crossing determination flag (R), 0 is used as the crossing determination flag (L) for the determination of the condition C.

### Rule 2

In a case where 0 is set as the crossing determination flag (R), the previous road shoulder determination flag (L) is used as the crossing determination flag (L) for the determination of the above condition C.

In the present embodiment, the position identifying unit 54 keeps on determining that the vehicle V is present on the left road shoulder D after determining that the vehicle V has entered the left road shoulder D on the local map in the entry determining process and until determining that the vehicle V has crossed the left own delimiting line A2 again to return to the own lane A on the local map.

### <Mrm>

When the vehicle V is traveling autonomously in the autonomous driving mode, it may sometimes be difficult to continue the travel of the vehicle V in the autonomous driving mode due to the malfunction of an autonomous driving function or the like. In such a case, the travel control unit 42 makes a driving intervention request to the occupant via the HMI 14. In a case where the occupant responds to the driving intervention request, the mode setting unit 43 switches the driving mode of the vehicle V from the autonomous driving mode to the manual driving mode. On the other hand, in a case where the occupant does not respond to the driving intervention request, the travel control unit 42 executes a Minimal Risk Maneuver (MRM: an example of emergency stop control). In the MRM, the travel control unit 42 causes the vehicle V to travel autonomously to a prescribed stop position in the autonomous driving mode while degenerating the autonomous driving function, and stops the vehicle V at the stop position.

When the MRM is not executed, the travel control unit 42 prohibits the vehicle V from traveling if the position identifying unit 54 determines that the vehicle V is present on the road shoulder D. Namely, when the MRM is not executed, the travel control unit 42 prohibits the vehicle V from traveling on the road shoulder D.

On the other hand, when the MRM is executed, the travel control unit 42 allows the vehicle V to travel until the vehicle V stops at the stop position on the road shoulder D, even if the position identifying unit 54 determines that the vehicle V is present on the road shoulder D. Namely, when the MRM is executed, the travel control unit 42 allows the vehicle V to travel on the road shoulder D until the vehicle V stops at the stop position on the road shoulder D.

### <Effect>

In the present embodiment, the position identifying unit 54 determines that the vehicle V has entered the road shoulder D on the local map upon determining that the adjacent lane B is not present on one lateral side of the own lane A and that the vehicle V has crossed the own delimiting line A2 on the one lateral side. Accordingly, it is possible to accurately determine that the vehicle V has entered the road shoulder D on the local map. In particular, by determining that the vehicle V has entered the road shoulder D on the local map only when determining that the adjacent lane B is not present on the one lateral side of the own lane A, it is possible to reliably avoid determining that the vehicle V has entered the road shoulder D even though the vehicle V has entered the adjacent lane B.

Further, the position identifying unit 54 keeps on determining that the vehicle V is present on the road shoulder D after determining that the vehicle V has entered the road shoulder D on the local map and until determining that the vehicle V has crossed the own delimiting line A2 again to return to the own lane A on the local map. Accordingly, after the vehicle V has entered the road shoulder D, it is possible to accurately determine whether the vehicle V is present on the road shoulder D. Accordingly, when the MRM is executed, the vehicle V can be surely stopped on the road shoulder D.

In another embodiment, the position identifying unit 54 may determine that the vehicle V is present on the road shoulder D in a case where a prescribed period has passed after determining that the vehicle V has entered the road shoulder D on the local map without determining that the vehicle V has crossed the own delimiting line A2 again to return to the own lane A on the local map. Accordingly, in a case where the vehicle V returns to the own lane A immediately after entering the road shoulder D, the position identifying unit 54 can avoid determining that the vehicle V is present on the road shoulder D.

Further, in a case where the adjacent lane B can be identified on one side of the vehicle V on the local map and the distance between the center line A1 of the own lane A and the center line B1 of the adjacent lane B on the local map is less than the reference value R, the position identifying unit 54 determines that the adjacent lane B is present. Accordingly, it is possible to accurately determine whether the adjacent lane B is present, and thus more accurately determine that the vehicle V has entered the road shoulder D on the local map.

Further, in a case where the center V1 of the vehicle V has crossed the own delimiting line A2 and has shifted from the own delimiting line A2 by the prescribed reference length L or more on the local map, the position identifying unit 54 determines that the vehicle V has crossed the own delimiting line A2 regardless of whether the whole of the vehicle V has crossed the own delimiting line A2. Accordingly, it is possible to accurately determine whether the vehicle V has crossed the own delimiting line A2, and thus more accurately determine that the vehicle V has entered the road shoulder D on the local map.

Further, when the MRM is not executed, the travel control unit 42 prohibits the vehicle V from traveling on the road shoulder D, and when the MRM is executed, the travel control unit 42 permits the vehicle V to travel on the road shoulder D until the vehicle V stops at the stop position on the road shoulder D. Accordingly, by temporarily permitting the vehicle V to travel on the road shoulder D when the MRM is executed, the vehicle V can be stopped at an appropriate stop position on the road shoulder D.

Further, the position identifying unit 54 determines that the vehicle V has entered the road shoulder D on the local map upon determining that the information on the local map is available, that the adjacent lane B is not present on the one lateral side of the own lane A (the vehicle V), and that the vehicle V has crossed the own delimiting line A2 on the one lateral side. Accordingly, by determining that the vehicle V has entered the road shoulder D on the local map only when the information on the local map is available, it is possible to more accurately determine that the vehicle V has entered the road shoulder D on the local map. However, in another embodiment, the position identifying unit 54 may omit the determination as to whether the information on the local map is available.

Further, in a case where the position of the vehicle V can be estimated on the local map, the position identifying unit 54 determines that the information on the local map is available, and in a case where the position of the vehicle V cannot be estimated on the local map, the position identifying unit 54 determines that the information on the local map is not available. Accordingly, it is possible to accurately determine whether the information on the local map is available, and thus more accurately determine that the vehicle V has entered the road shoulder D on the local map.

Concrete embodiments of the present invention have been described in the foregoing, but the present invention should not be limited by the foregoing embodiments and various modifications and alterations are possible within the scope of the present invention.

1. A vehicle control system, comprising:
a map generating unit configured to generate a map of a surrounding area of a vehicle; and
a road shoulder determining unit configured to determine whether the vehicle has entered a road shoulder on the map,
wherein the road shoulder determining unit is configured to
identify an own lane on which the vehicle is traveling on the map,
determine whether an adjacent lane adjacent to the own lane is present on the map,
determine whether the vehicle has crossed an own delimiting line that delimits the own lane on the map, and
determine that the vehicle has entered the road shoulder on the map upon determining that the adjacent lane is not present on one lateral side of the own lane and that the vehicle has crossed the own delimiting line on the one lateral side.

2. The vehicle control system according to claim 1, wherein the road shoulder determining unit keeps on determining that the vehicle is present on the road shoulder after determining that the vehicle has entered the road shoulder on the map and until determining that the vehicle has crossed the own delimiting line again to return to the own lane on the map.

3. The vehicle control system according to claim 1, wherein the road shoulder determining unit determines that the vehicle is present on the road shoulder in a case where a prescribed period has passed after determining that the vehicle has entered the road shoulder on the map without determining that the vehicle has crossed the own delimiting line again to return to the own lane on the map.

4. The vehicle control system according to claim 1, wherein in a case where the adjacent lane can be identified on one side of the vehicle on the map and a distance between a center line of the own lane and a center line of the adjacent lane on the map is less than a prescribed reference value, the road shoulder determining unit determines that the adjacent lane is present.

5. The vehicle control system according to claim 1, wherein in a case where a center of the vehicle has crossed the own delimiting line and has shifted from the own delimiting line by a prescribed reference length or more on the map, the road shoulder determining unit determines that the vehicle has crossed the own delimiting line regardless of whether a whole of the vehicle has crossed the own delimiting line.

6. The vehicle control system according to claim 1, further comprising a travel control unit configured to control travel of the vehicle,
wherein the travel control unit is configured to execute emergency stop control to cause the vehicle to autonomously travel to a prescribed stop position and stop at the stop position upon determining that it is difficult to continue the travel of the vehicle,
when the emergency stop control is not executed, the travel control unit prohibits the vehicle from traveling on the road shoulder, and
when the emergency stop control is executed, the travel control unit permits the vehicle to travel on the road shoulder until the vehicle stops at the stop position on the road shoulder.

7. The vehicle control system according to claim 1, wherein the road shoulder determining unit is configured to
determine whether information on the map is available, and
determine that the vehicle has entered the road shoulder on the map upon determining that the information on the map is available, that the adjacent lane is not present on the one lateral side of the own lane, and that the vehicle has crossed the own delimiting line on the one lateral side.

8. The vehicle control system according to claim 7, wherein in a case where a position of the vehicle can be estimated on the map, the road shoulder determining unit determines that the information on the map is available, and
in a case where the position of the vehicle cannot be estimated on the map, the road shoulder determining unit determines that the information on the map is not available.

9. A road shoulder entry determining method for determining whether a vehicle has entered a road shoulder on a map, the road shoulder entry determining method comprising:
identifying an own lane on which the vehicle is traveling on the map,
determining whether an adjacent lane adjacent to the own lane is present on the map,
determining whether the vehicle has crossed an own delimiting line that delimits the own lane on the map, and
determining that the vehicle has entered the road shoulder on the map upon determining that the adjacent lane is not present on at least one lateral side of the own lane and that the vehicle has crossed the own delimiting line on the one lateral side.
